(19) United States
(12) Patent Application Publication
(10) Pub. No.: US 2007/0222254 A1
(43) Pub. Date: Sep. 27, 2007

(54) Arrangement for controlling the motion of the swiveling parts of a vehicle

(76) Inventor: Tobias Wagner, Hamburg (DE)

Correspondence Address: JORDAN AND HAMBURG LLP, 122 EAST 42ND STREET, SUITE 4000, NEW YORK, NY, 10168, US

(21) Appl. No.: 11/726,553

(22) Filed: Mar. 22, 2007

(30) Foreign Application Priority Data
Mar. 23, 2006 (DE) 10 2006 013 924.0

(51) Int. Cl. B60J 7/14; B60J 7/20

(52) U.S. Cl. 296/108; 296/107.08

(57) ABSTRACT

The invention relates to an arrangement for controlling the motion of the swiveling parts of a vehicle. The task of this invention to overcome the disadvantages of the state of the art in a simple manner and to provide an arrangement for controlling the motion of the swiveling parts of a vehicle without much effort is solved by an arrangement that controls the motion of the swiveling parts of a vehicle, such as a convertible top and/or a rear lid, and includes at least one distance sensor and one control unit, which controls the motion of at least one motor by means of which the vehicle parts can be set into motion, and distance sensor and control unit set upon the motion in a controlling manner.

### BACKGROUND OF THE INVENTION

The invention relates to an arrangement for controlling the motion of the swiveling parts of a vehicle such as a convertible top and/or a rear lid.

The convertible tops of today are equipped with drives that allow to open and close them automatically. For this purpose, motors for the different single motions of the convertible top are arranged in the kinematic system and are controlled via an electronic circuit. In order to control the single motions, the various components (e.g. locks, top, clamp clips, convertible top compartment lid) are provided with limit stop switches that will give a signal to a control unit if the components reach defined positions. Said control unit coordinates the motions and triggers e.g. the valves of a drive hydraulic system.

For example, DE 101 11 705 A1 describes a convertible top system with complex multi-articulation hydraulic elements that are normally driven by hydraulic cylinders and transmit the rotary motions via rods to the convertible top parts to be moved.

EP 1 160 113 A2 explains the use of swivel motors as electrically or hydraulically driven actuators that are fixed in the main bearing at the vehicle body and/or are arranged at important articulation points between the rigid top parts.

For determining and controlling the position of a convertible top, the publication DE 199 52 590 A1 details an arrangement that allows to reliably and precisely record the position of the movable hydraulic elements and thus of the convertible top, because each hydraulic element is provided with a sensor designed as a restrictive displacement transducer that is integrated into the hollow-drilled piston of the piston of the hydraulic cylinder and the change of its output signal (change in the output voltage) is evaluated by a control unit.

DE 199 18 628 A1 describes a convertible top kinematic system driven by a piston rod. The position of the articulated lever of said kinematic system is detected by means of sensing microswitches or potentiometers and is transmitted in the form of signals to a microprocessor to control the extension and retraction motions of the piston rod.

U.S. Pat. No. 5,225,747 explains an arrangement with a measuring unit in the form of a sensor, such as e.g. a potentiometer, that is installed on a rotation axis and is used for determining and controlling the position of a convertible top.

DE 692 08 444 T3 reports a sensor system that records the position of the individual components over the complete path of motions and coordinates the motion of the components in such a way that the various components can be triggered in a temporally superposed manner, e.g. for accelerating the opening operation of a convertible top.

The control of convertible top systems by means of limit stop switches leads to a mere sequential course of motions. One motion runs after the other so that the time required for the complete opening process of a convertible top is long. Moreover, the power of the drive system is not exploited over long phases of the process because the sequences of the motion of the various components have different power requirements so that the running time is not determined by the driving power but by parameters such as the maximum torque (electric motors) or the maximum volume flow rate (hydraulic system).

The control described in DE 692 08 444 T3 requires the arrangement of sensors (e.g. of a rotary potentiometer) within the kinematic system of a convertible top, i.e. in an extremely space-restricted zone. Additionally, damages and system failures can be caused by the fact that due to the kinematic arrangement the cables to the sensors must be partly led via several rotary axes.

For the coordination of the simultaneous motions of several components, the individually measured motion coordinates must be evaluated and their common effect must be calculated. The measurement of the positions of the moved components is indirectly taken via the angle positions in the kinematic system and thus it is subject to considerable tolerance variations in the components. To avoid collisions, this effect leads to high tolerance increases for the distances to be kept and thus to losses of the time that is required for the actuating process.

The task of this invention is to avoid the described disadvantages of the state of the art in a simple manner and to provide an arrangement for controlling the swiveling parts of a vehicle, e.g. convertible tops and/or rear lids, that can be realized without many efforts. Furthermore, a procedure for approaching the limit positions shall be explained.

### SUMMARY OF THE INVENTION

The invention is based on the use of systems for measuring the distances of the convertible top components to each other during the motion of the top.

In the convertible top system, distance sensors (e.g. ultrasonic sensors) are installed at suited positions. The sensor signals are evaluated in a central control unit that has an information/data-transferring connection with the distance sensors and the received values are used for coordinating the superposed motions of a convertible top and a rear lid. Like the system described in DE 692 08 444 T3, the inventive arrangement allows the control of the convertible top components in at least partly simultaneous motions thus considerably reducing the time required for the complete motion process of the convertible top. Moreover, the system power can be distributed to several components and thus it can be better exploited.

In the inventive solution, considerably fewer signals than in the state-of-the-art arrangements have to be evaluated for coordinating the motions. Independent of the kinematic elements, the distance sensors can be installed at positions of the convertible top at which the relevant distances for the coordination of the motions must be kept. Thus, the measurement is directly taken at the position where a collision must be avoided and that is why it is not subject to any tolerances of the kinematic elements. Thus, a closer superposition of the single sub-motions of the convertible top is possible.

The invention comprises apparatus for controlling swiveling parts of a vehicle, especially a convertible top and/or a rear lid for overlying the convertible top when the convertible top is in retracted (folded) positions. Respective distance sensors may be positioned at the convertible top and/or at the rear lid. The motors may each be a kinematic motor for setting the convertible top and/or the rear lid into motion for individual (respective) convertible top functions. The distance sensor may be an ultrasonic sensor. The distance sensor and the control unit may control speed of motion of the convertible top and/or the rear lid as they approach their limit positions.

### BRIEF DESCRIPTION OF THE DRAWINGS

In the following, four examples explain the invention in detail in a schematic drawing. They show:

FIG. 1a an inventive arrangement with the convertible top closed,

FIG. 1b an inventive arrangement according to FIG. 1a shortly after the start of the motion sequence,

FIG. 1c an inventive arrangement according to FIG. 1a at a point in time at which the critical distance between the convertible top and the rear lid is reached,

FIG. 1d an inventive arrangement according to FIG. 1a after reaching the point in time according to FIG. 1c, with the distance between the convertible top and the rear lid being determined by the distance sensor and the top motors controlled by the control unit keep said distance in a state in which the risk of collision is not given,

FIG. 1e the inventive arrangement according to FIG. 1a shortly before reaching the limit position of the opened convertible top with the distance between the convertible top and the rear lid being not critical for a collision so that the distance sensor 1 is put out of operation,

FIG. 1f an inventive arrangement according to FIG. 1a at the point of time at which the convertible top is put down in the rear zone of the vehicle and the distance sensor 1 is out of operation, and

FIG. 1g the inventive arrangement according to FIG. 1a at the point in time at which the rear lid closes, with the distance sensor 1 being active and recording the distance when the rear lid is approaching the closing system, and the control unit reduces the speed of the motors of the top kinematic system to prevent the rear lid from hitting.

### DETAILED DESCRIPTION OF THE INVENTION

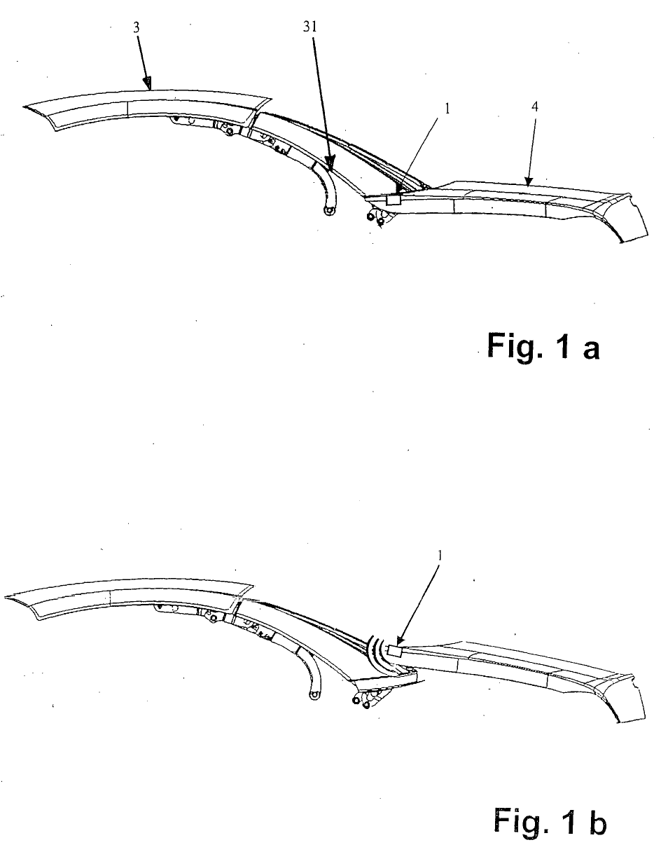

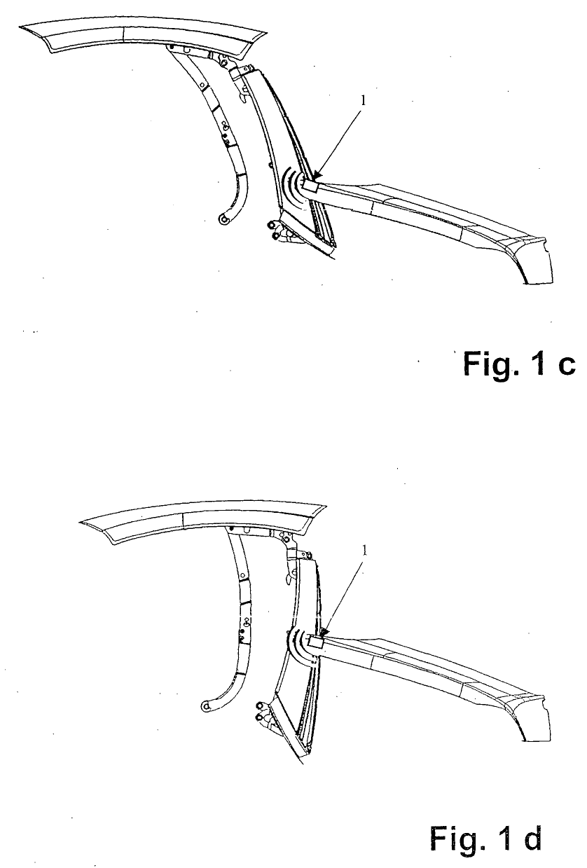

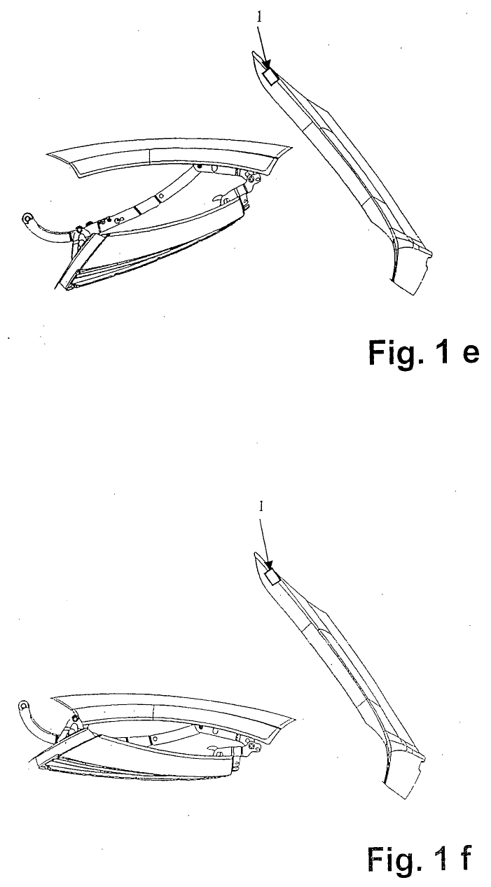

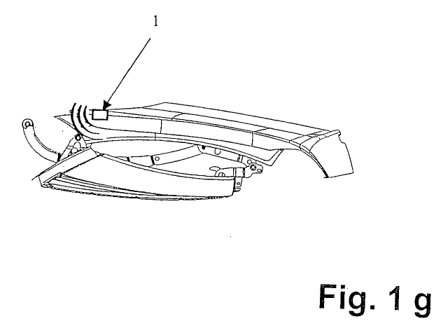

The arrangement of FIG. 1 for determining and controlling the position of a swiveling top component/a convertible top and a rear lid 4 includes at least one distance sensor 1 and a control unit that is not shown in the figure for ensuring a better overview. Said sensor and control unit are connected for information/data transfer purposes and make it possible to register the distance of the rear external surface 31 of the convertible top 3 to the rear lid 4 and to control it by means of the intervention of the control unit into the motion of the convertible top kinematic motors (neither shown in the figure to ensure a better overview) that move the convertible top 3 for the individual top functions.

A particular advantage of this arrangement is that the distance sensor 1 is designed as an ultrasonic sensor that is installed at the rear lid 4.

The distance sensor 1 is preferably positioned at the side of the rear lid 4 that faces the convertible top 3.

In the opening mode of the convertible top 3, the distance sensor 1 receives the ultrasound emitted by it and reflected by the convertible top 3, and the emission of the ultrasound begins at the start of the motions of the convertible top 3 and the rear lid 4. (FIGS. 1a and 1b).

Depending on the distance value measured by the distance sensor 1 and compared with a pre-definable rated balance value, the distance of the convertible top 3 to the rear lid 4 is determined. The measured distance values are transmitted by the distance sensor 1 to the control unit in which the rated balance value is stored.

The individual rated balance values can be defined for the various positions of the convertible top 3 during the mounting of the convertible top 3 onto the vehicle by positioning the vehicle onto an ideally plane surface and bringing the top into a position in which critical distances between the convertible top 3 and the rear lid 4 are reached. These rated balance values are stored in the control unit.

During the motion sequence of the convertible top 3 and the rear lid 4, the position data measured by the distance sensor 1 continuously or from time to time are transmitted to the control unit that compares them with the corresponding rated balance value so that the control unit not shown in the figures drives the top kinematic motors, which are also not shown in the figures, so that the motion of the convertible top 3 can be controlled.

In the closing mode, the convertible top 3 and the rear lid 4 run through the steps according to FIG. 1g through 1a in the reverse order of the opening mode with these steps being controlled by the distance sensor 1, the control unit and the top kinematic motors (not shown in the figures).

Compared to the arrangements of the state of the art, the inventive solution offers the following advantages:
reduction of time required for the complete motion sequence of the convertible top
better exploitation of the power of the drive system
lower number of sensors
positioning of the sensors outside space-critical zones
reduced measurement and calculation requirements
measurement performed directly in the collision range, and
optimized sequence time.

All elements presented in the description, the subsequent claims and the drawing can be decisive for the invention both as single elements and in any combination.

### LIST OF REFERENCE NUMERALS

| | |
|---|---|
| 1 | distance sensor |
| 3 | convertible top |
| 31 | external surface |
| 4 | rear lid |

1.-6. (canceled)

7. An arrangement comprising at least one swiveling part of a vehicle and apparatus for controlling motion of the at least one swiveling part, the apparatus comprising at least one motor for setting the at least one swiveling part into motion, at least one distance sensor for sensing a position of the at least one swiveling part, and a control unit communicating with the at least one distance sensor and the at least one motor.

8. The arrangement according to claim 7, wherein the at least one vehicle part comprises a convertible top and/or a rear lid for overlying the convertible top when the convertible top is in retracted positions and each of the motors is a kinematic motor for setting the convertible top and/or the rear lid into motion for individual convertible top functions.

9. The arrangement according to claim 8, wherein the at least one swiveling part comprises the rear lid and one said distance sensor is positioned at the rear lid.

10. The arrangement according to claim 8, wherein the at least one swiveling part comprises the convertible top and one said distance sensor is positioned at the convertible top.

11. The arrangement according to claim 8, wherein the distance sensor is an ultrasonic sensor.

12. The arrangement according to claim 8, wherein the distance sensor and the control unit comprise means for controlling speed of motion of the convertible top and/or the rear lid as they approach their limit positions.
